(19) United States
(12) Patent Application Publication
(10) Pub. No.: US 2010/0109529 A1
(43) Pub. Date: May 6, 2010

(54) ARCTUBE FOR INDUCTION HIGH INTENSITY DISCHARGE LAMP

(75) Inventors: Gary Robert Allen, Chesterland, OH (US); David C. Dudik, South Euclid, OH (US); Svetlana Selezneva, Schenectady, NY (US); Joshua Ian Rintamaki, Westlake, OH (US)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/609,048

(22) Filed: Oct. 30, 2009

Related U.S. Application Data
(60) Provisional application No. 61/110,406, filed on Oct. 31, 2008.

(51) Int. Cl. H01J 61/30; H01J 9/24

(52) U.S. Cl. 313/634; 445/22

(57) ABSTRACT

An oblate spheroidal arctube body geometry provides for a significant reduction in stress cracks and results in lamps that operate at greater than 400 watts for extended periods of time leading up to greater than 20,000 hours. Preferably, the major diameter (OD) ranges between approximately 20 and 40 mm. Wall thickness (T) is preferably on the order of approximately 1.0 to 3.0 mm. An aspect ratio defined as AR (major axial dimension/minor axial dimension) is preferably between 1.1 and 2.0. A radius of curvature (R1) between the spheroidal portion and the leg of the arctube body preferably ranges from—approximately 3 mm to 12 mm or which can be expressed as a curvature 1/R1 ranging from 0.08 to 0.33 mm⁻¹.

This application claims priority from U.S. provisional application Ser. No. 61/110,406, filed 31 Oct. 2008, the entire disclosure of which is expressly incorporated herein by reference.

### BACKGROUND OF THE DISCLOSURE

The present disclosure relates generally to electrodeless high intensity discharge (HID) lamps. More particularly, the present disclosure is directed to optimizing the isothermal design of the arctube envelope resulting in optimal performance along with reducing crack formation associated with stress in a ceramic arctube of this type.

HID lighting, most of which was first developed in the 1960's, provides approximately 20% of all artificial light globally. Metal halide HID lamps account for about one-half of the HID total and is the area growing most quickly. HID lamps are selected for a number of uses because of the unique combination of high efficacy, high-brightness, high wattage, long life, and good color. The electroded ceramic metal halide (CMH) lamp, for example, introduced in the mid-1990's presently provides one of the best combination of performance at approximately 100 lumens per watt (LPW), luminance or brightness on the order of 1 to a few mega-nits (candela/m̂2), operational up to 400 W, and provides a life of up to 20,000 hours, and up to 90+Ra.

A high-wattage (>100 W) induction HID lamp was previously developed by the assignee of the present disclosure, see for example, U.S. Pat. Nos. 4,810,938, 5,032,757, 5,039,903, 5,150,015 and 5,214,357, the disclosures of which are incorporated herein by reference. However, widespread commercialization of this lamp was not pursued for a variety of reasons, such as the inability to maintain a long-term stable arc apparently due to a loss of sodium (Na) from the quartz arc chamber. A target lamp life of greater than approximately 20,000 hours was not possible at vessel temperatures that would provide sufficiently high photometric performance.

Ceramics, particularly poly-crystalline alumina (PCA), are widely used in CMH lamps. PCA exhibits a much slower rate of sodium loss from the arc chamber than does quartz, and so it is an interesting candidate material for a high-wattage induction HID lamp, as cited in U.S. Pat. Nos. 4,810,938, 5,032,757; 5,621,275, 5,727,975; 6,666,739; 6,856,092; and 5,637,963. But this material is relatively brittle and temperature differences or temperature gradients tend to cause cracks, very often in the equatorial zone of the arc chamber, or in the fillet zone between the arc chamber and the electrode leg. Cracking in ceramic HID arctube bodies is primarily due to stresses that are typically proportional to temperature differences between locations along the ceramic body. So there is a need to control cracking by reducing temperature differences, and thereby stresses in order for a ceramic metal halide lamp to develop into a commercially viable lighting product. The tensile stress must typically not exceed about 100 MPa (megapascals) at any location in the ceramic arctube body in order to avoid cracking for tens of thousands of hours of operation at the typical temperature of about 1200 to 1300 K for a CMH lamp.

The electrodeless lamp design, i.e., no electrodes extending through the arctube body and into the discharge chamber, uses a surrounding annular coil through which a time-changing current creates a time-changing magnetic field and corresponding time-changing electric field within the arc chamber so that once ignition of the fill gas is initiated, a donut-shape or toroidal plasma is established in the arctube body and emits light therefrom. The use of PCA, instead of the traditional quartz, for an induction HID lamp can greatly inhibit the loss of Na, and potentially extend the life of the lamp much longer than 20,000 hours. However, until the cracking issue is resolved, the commercial potential for this lamp remains low. Therefore, a need exists for addressing the thermal stress issues in an arctube body of an induction HID lamp. A solution for the stress-driven cracking in a high-wattage ceramic induction HID lamp has not been previously discovered. The preferred dimensional design of the arctube is one that minimizes temperature differences within the ceramic arctube during lamp operation, a condition that is advantageous to both ceramic and quartz arctubes.

### SUMMARY OF THE DISCLOSURE

A high-wattage electrodeless induction high intensity discharge lamp includes a ceramic envelope or arctube body having a generally oblate spheroidal portion and at least one elongated leg, preferably an elongated cylindrical portion extending from the spheroidal portion. An induction coil surrounds, at least in part, the spheroidal portion of the arctube body for supplying power from an associated ballast. The dimensions of the arctube body are identified that minimize stresses in the ceramic to provide a commercially useful life of the lamp.

The spheroidal portion has an outside major axis dimension (major diameter, or OD) in the range of approximately twenty to forty millimeters (20-40 mm), depending on the lamp wattage. For the example of a 400 W lamp, the preferred range is approximately 23 to 33 mm, and more preferably 26 to 30 mm.

A wall thickness (T) on the order of approximately 1.0 to 3.0 mm is preferred, and more preferably is about 2.0 mm.

An aspect ratio (AR) of the major and minor outside diameters on the order of approximately 2.0 and 1.1 is preferred, and more preferably is about 1.4.

A neck portion interconnects a second portion or leg of the arctube body with the spheroidal portion with a radius of curvature (R1) of approximately 3 mm to 12 mm, or more equivalently, a curvature (1/R1) on the order of 0.33 to 0.08 mm⁻¹.

What is significantly different in this disclosure is the discovery of a unique shape of the ceramic vessel, and thereby the ability to optimize a larger set of arctube body parameters that enable extreme reduction in stresses and consequently offer the potential for extremely long lamp life, possibly on the order of 50,000 hours.

A preferred geometry of the ceramic arctube body is mounted inside the turn or turns of an annular ring-shaped induction coil that provides radio-frequency (RF) power from an associated ballast and is surrounded by beam-forming optical component(s). The entire lamp-ballast-luminaire system converts electrical power to an output light beam for illumination at very high lumen levels of approximately 40,000 lumens and greater from a typical 400 W lamp, and extremely high system efficiency (light in the beam divided by input electrical power from the mains supply) exceeding 100 LPW.

Compared with a traditional high-wattage electroded CMH lamp, the induction or electrodeless CMH lamp-ballast-luminaire system potentially provides approximately 30-50% higher system LPW and lumens, up to and beyond 400 W, and achieves on the order of two to three times longer life, with acceptable color for many applications.

The induction CMH lamp is also advantageously Hg-free, whereas none of the emerging Hg-free lamp designs for electroded HID lamp offer efficacy competitive with an equivalent Hg-dosed lamp.

The Hg-free induction CMH lamp provides an eco-friendly lighting product, that is generally deemed unrivaled by any present light source. The induction CMH lamp of the present disclosure therefore has the potential to serve a significant percentage of the present high-wattage HID market.

### BRIEF DESCRIPTION OF THE DRAWINGS

FIG. 1 is a perspective view of an electrodeless lamp received within an RF coil.

FIG. 2 is a longitudinal cross-sectional view through an arctube body of the present disclosure.

FIG. 3 is a perspective view of the geometry of an oblate spheroid.

FIG. 4 is a plan view of the geometry of an oblate spheroid.

FIG. 5 is a plot of the maximum temperature in the ceramic envelope and the temperature at the cold spot of the ceramic envelope where the metal halide dose condenses versus the major outside diameter (OD) and the aspect ratio (AR) of the ceramic envelope. In the white zone the lamp design satisfies the combination of the two requirements: maximum ceramic temperature <1300 K; and temperature of the cold spot where the metal halide dose condenses >1150 K.

FIG. 6 is a plot of the maximum temperature in the ceramic envelope, the temperature at the cold spot of the ceramic envelope, and the tensile stress at the outside surface of the ceramic envelope near the major axis equator versus the major outside diameter (OD) and the aspect ratio (AR) of the ceramic envelope. In the white zone the lamp design satisfies the combination of the three requirements: maximum ceramic temperature <1300 K; and temperature of the cold spot where the metal halide dose condenses >1150 K; and the maximum tensile stress at the outside surface of the ceramic envelope near the major axis equator <70 MPa.

FIG. 7 is a plot of the tensile stress on the inside surface of the arctube body near the transition region (neck) between the cylindrical leg portion and the oblate spheroidal portion of the arctube body plotted versus the radius of curvature (R1) of the inside surface in the transition between the cylindrical leg portion and the oblate spheroidal portion of the arctube body, and vs. the major outside diameter (OD). In the white zone the lamp design satisfies the requirement that the maximum tensile stress at the inside surface of the arctube body near the transition region between the cylindrical leg portion and the oblate spheroidal portion of the arctube body <75 MPa, and the black zone denotes stress >100 MPa.

### DETAILED DESCRIPTION OF THE PREFERRED EMBODIMENTS

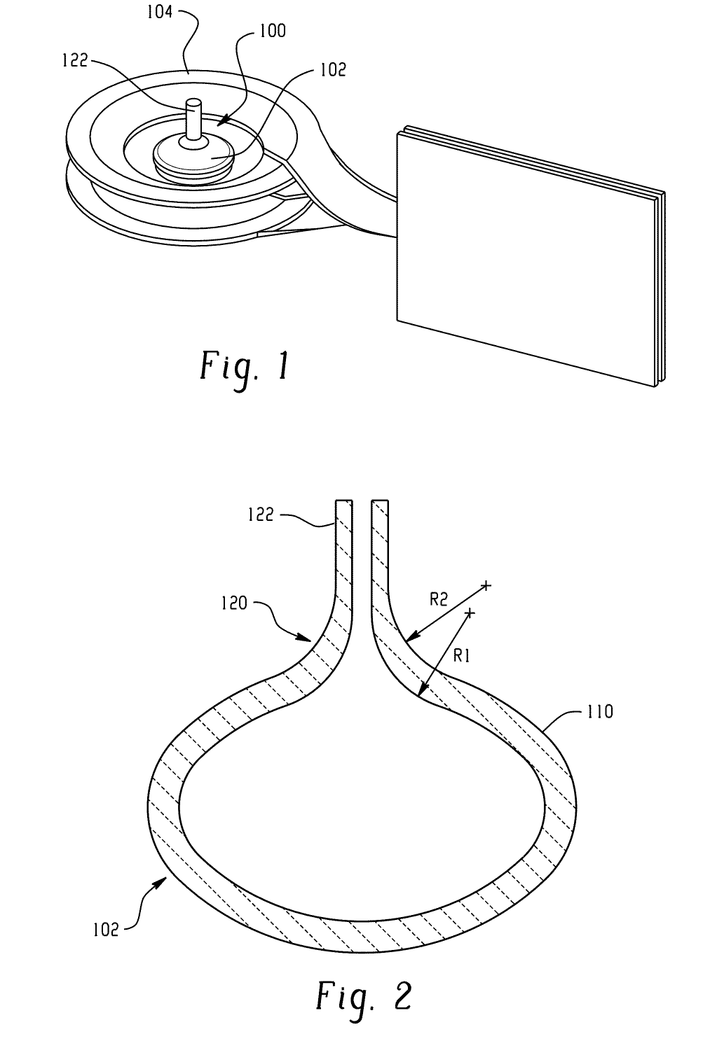

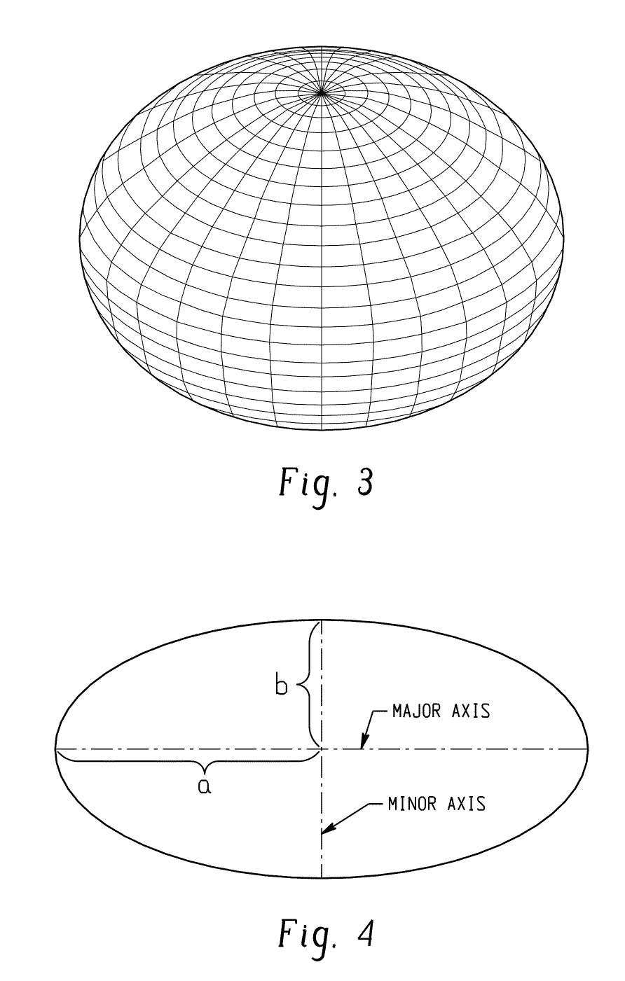

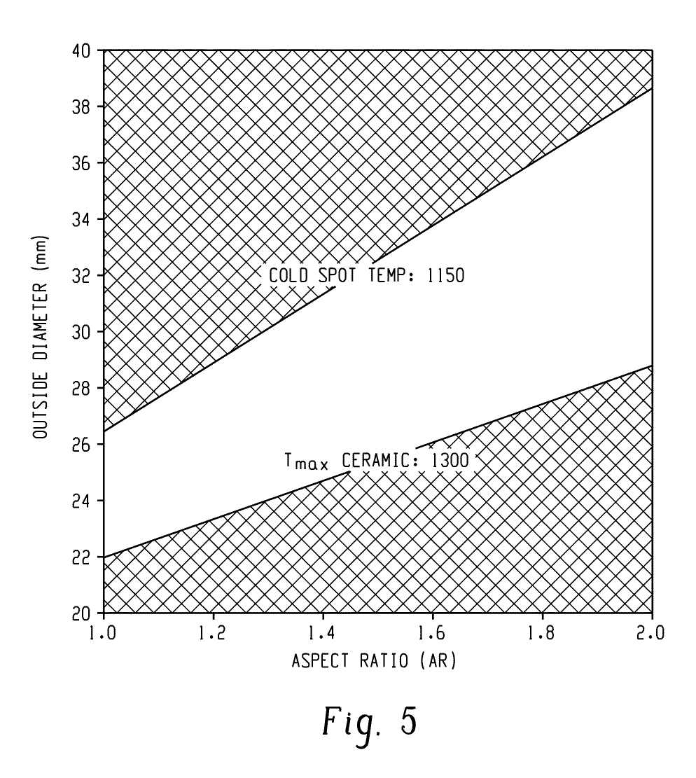

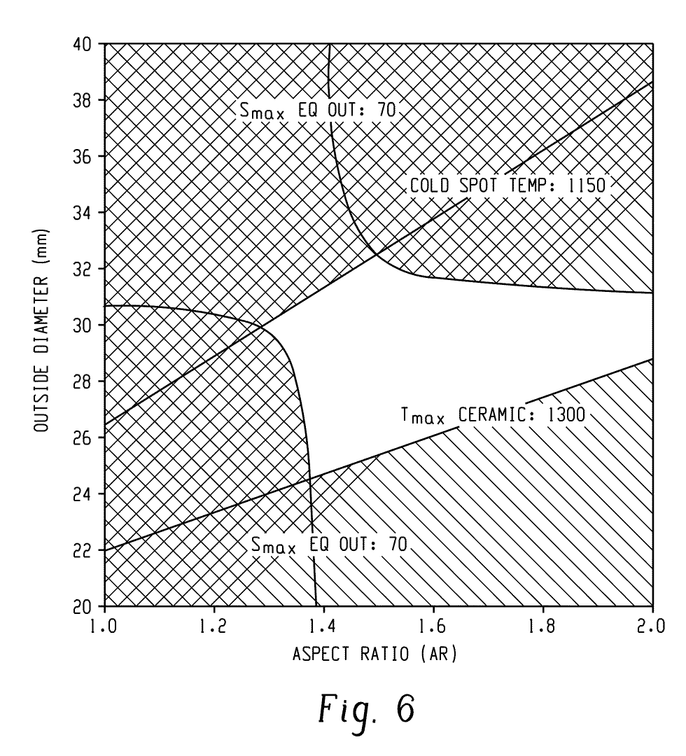

FIG. 1 shows an electrodeless lamp assembly 100 having an arctube body 102 received within an RF coil 104. The arctube body encloses a fill or dose that generates light upon excitation. The RF coil generates a magnetic field to excite the plasma. Generally, this structure and operation is known. With continued reference to FIG. 1, and additional reference to FIG. 2, the arctube body 102 is a ceramic body, preferably a polycrystalline alumina (PCA) having a first or spheroidal portion 110 connected to neck 120 that merges into a second or leg portion 122. Although only one leg is illustrated, one skilled in the art will recognize that embodiments employing more than one leg would fall within the scope and intent of the present disclosure. FIGS. 3 and 4 show perspective and plan views of the geometry of the inside an oblate spheroid envelope, representing the spheroidal section of the hollow arctube body, where the Major Radius “a” and Minor Radius “b” are defined. FIG. 5 is a plot of the maximum temperature in the ceramic envelope, and the temperature at the cold spot of the ceramic envelope, plotted vs. the major outside diameter (OD) and the aspect ratio (AR) of the ceramic envelope. In the white zone, the combination of OD and AR are such that the design of the ceramic envelope satisfies the conditions of maximum temperature <1300 K, and cold spot temperature >1150 K. Outside of the white zone, one or both of those conditions is not met, so that the design of the ceramic envelope is undesirable. FIG. 6 is a plot of the maximum temperature in the ceramic envelope, and the temperature at the cold spot of the ceramic envelope, and the stress at the outside surface of the major axis, plotted vs. the major outside diameter (OD) and the aspect ratio (AR) of the ceramic envelope. In the white zone, the combination of OD and AR are such that the design of the ceramic envelope satisfies the conditions of maximum temperature <1300 K, and cold spot temperature >1150 K, and the stress at the outside surface of the major axis <70 MPa.

The electrodeless lamps were evaluated both by a Finite Element Analysis computer model and by measurements of operating lamps at various power levels ranging from less than 300 watts to 500 watts, and above. The temperature was measured in the lamps, and sampled in the model, at various locations, namely at the poles, at the equator, along neck 120 interconnecting the first spheroidal portion 110 with the leg 122, and intermediate locations, etc. The ideal measurements would be an equal operating temperature at each of these locations representing no thermal gradients and consequently no induced thermal stresses that lead to cracking issues. A multi-response optimization of the results of several Design of Experiments (DoE) incorporating results from the model and from measured lamps provided transfer functions for the temperature and stress at the various locations on the arctube body. The transfer functions enabled optimization of the input factors of the DoEs at a given lamp power such that the desired maximum temperature of the ceramic (to avoid deterioration of the ceramic properties), minimum temperature of the spheroidal section (to provide high vapor pressure of the metal halides for efficacy and color) and minimum stress at the key locations (typically the equator and neck regions) of the ceramic arctube body (for long lamp life) were determined. The transfer functions provided optimal arctube designs over a range of wattages that were built, measured, and life-tested as total lamp-ballast systems for thousands of hours to confirm the combination of high performance and long life, and also to enable interpolation and extrapolation versus lamp wattage over the range 200 W to >500 W.

In general, it is found that the optimal value of the outside major diameter OD scales like the square-root of the lamp power, as expected in most HID lamps, since that provides for a constant wall loading WL [watts/cm²] on the ceramic arctube body so that the target temperature is achieved at a particular lamp wattage. It is also found that the optimal value of the wall thickness T and the optimal radius of curvature in the neck region R1 are proportional to OD at a given lamp wattage. However, it is found that the optimal aspect ratio AR of the major and minor diameters of the outside surface of the spheroidal section of the arctube body is relatively independent of lamp wattage.

A first feature relates to the outside major diameter (OD) of the arctube body, and particularly the spheroid portion 110. The model and lamp results indicate that the OD is the main factor in determining the maximum and minimum temperatures in the ceramic envelope. The maximum temperature in the ceramic envelope should be less than about 1300 K to ensure long life of the lamp, while the temperature at the cold spot in the ceramic envelope should be greater than about 1150 K, to provide good photometric performance of the lamp. In the preferred arrangement, for a 400 W lamp, in order to provide for a maximum temperature in the ceramic envelope of less than about 1300 K, and a temperature at the cold spot in the ceramic envelope of greater than about 1150 K, the maximum OD ranges from 23-33 mm, and more preferably around 26-30 mm, as displayed graphically in FIG. 5.

The spheroidal portion 110 is an oblate (flattened) spheroid where the equatorial dimension of the spheroid has a major, or larger, diameter (left to right in FIG. 2) that is greater than a minor, or smaller, diameter in the polar direction (top to bottom in FIG. 2). This relationship between the major and minor axes (major outer diameter/minor outer diameter) is generally referred to as the aspect ratio (AR), where the major axis diameter in the illustrated embodiment is the equatorial diameter (major OD) that is divided by minor axis or the polar diameter (minor OD). With regard to preferred design parameters, the aspect ratio may also be referenced as an inverse relationship, namely 1/AR. The model and lamp experiment results indicate that the AR is the main factor, along with R1, in determining the tensile stress at the outside surface of the major axis equator in the ceramic envelope, which is primarily responsible for cracking of the ceramic in that location. A tensile stress of <100 MPa is generally considered to be necessary, and more preferentially <75 MPa, for long lamp life at the typical operating temperature of a CMH ceramic arctube composed of PCA. A range of 1/AR between approximately 0.5 and 0.9 is preferred, corresponding to AR approximately 1.1 to 2.0, and a more preferred ratio is approximately 1.3 to 1.6, as shown in FIG. 6.

In order to scale the OD to other lamp wattages P, while maintaining the proper heat flux to the ceramic wall to achieve the most desirable temperature, the wall loading WL on the inside surface of the oblate spheroid should be kept approximately constant, where WL=P/SA, and SA is the inside surface area of the spheroidal section of the ceramic arctube body, given by

$$SA = 2 π [ {a}^{2} + \frac{{b}^{2}}{sin ( θ )} ln ( \frac{1 + sin ( θ )}{cos ( θ )} ) ] , where θ = arccos ( b / a ) .$$

In terms of WL, in the preferred arrangement, for any wattage in the range of about 200 W to 1000 W, WL ranges from about 20 W/cm² to about 45 W/cm², more preferentially from about 25 W/cm² to about 35 W/cm² for a given aspect ratio AR=a/b, the OD is thereby determined for any lamp power in the range of about 200 W to 1000 W by the Wall Loading WL and the Lamp Power P from the equations above. For the example of a 400 W lamp having AR ˜1.4, if the OD is less than 23 mm, then the ceramic operates too hot, since the wall loading is 46 W/cm² or more. If the OD is greater than 33 mm, the ceramic operates too cold to maintain sufficient vapor pressure of the light-radiating metal halide dose, since the wall loading is 20 W/cm² or less.

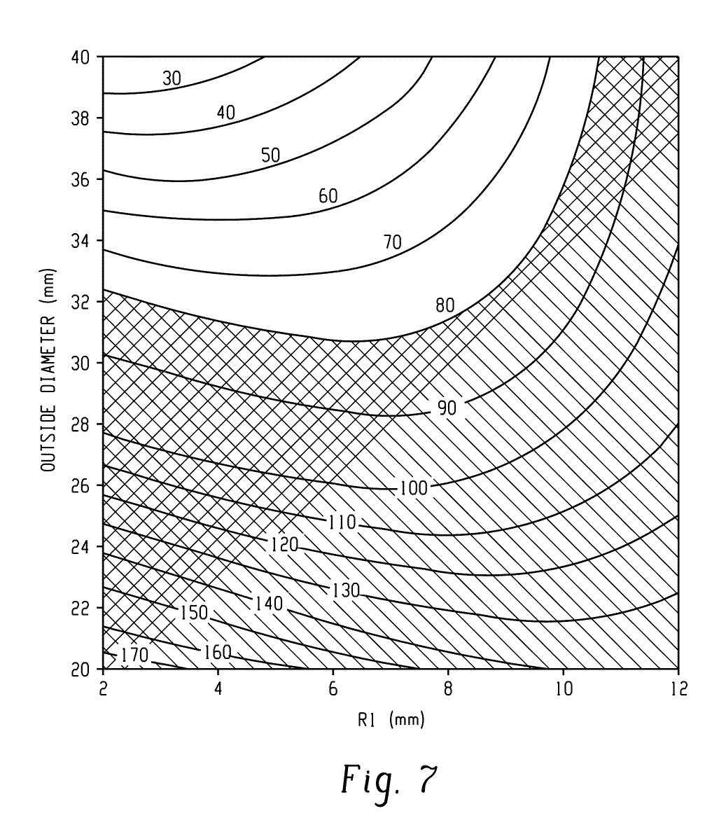

Another factor relates to the curvature in the neck region. This is defined as the inverse of the radius (R1) where the radii of curvature on the inside and outside surfaces of the neck region are R1, R2, respectively, and preferably the radii are approximately equal in the neck region, R1≈R2. The model and lamp experiment results indicate that R1 is the main factor in determining the tensile stress at the outside surface of the transition between the spheroidal portion 110 and the leg portion 122 of the arctube body, which is primarily responsible for cracking of the ceramic in that location. Preferably, the radius (R1) for a 400 W lamp ranges between 3 and 12 mm, and thus the inverse (1/R1) varies from 0.08 to 0.33 mm⁻¹, and more preferably R1 is approximately 6-10 mm for a 400 W lamp having an OD in the preferred range of 26 to 30 mm. This assures minimum stress in the transition between the spheroidal portion 110 and the leg portion 122 of the arctube body, as displayed graphically in FIG. 7. As will be appreciated, an isothermal relationship means there are reduced temperature differentials that, in turn, lead to reduced amounts of thermal expansion and less induced stress. Ultimately, reduced stress means there is less chance of cracking and improved, longer life. In order to scale the preferred range of R1 to other lamp wattages P, the ratio of Major Outer Diameter to the Neck Radius OD/R1 should be approximately constant, in the range of OD/R1=2 to 11, more preferably 2.6 to 5.0.

Still another parameter relates to wall thickness (T). It has been determined that minimization of the thermal stress imposed on the arctube body requires a wall thickness that ranges between 1.0 and 3.0 mm, and more preferably at approximately 1.5 to 2.5 mm. Increased wall thickness, up to some amount, reduces the ceramic temperature at all locations in the ceramic, but it enhances thermal conduction from hotter zones to cooler zones in the ceramic arctube body, thus providing a more isothermal arctube body, resulting in lower stress. Furthermore, a wall thickness less than some minimum of approximately 1 mm is very difficult to manufacture with good quality and reliability for ceramics having OD in the range of approximately 20 to 40 mm. However, beyond some amount, increased wall thickness produces undesirable temperature differences through the wall, producing higher stresses in the ceramic body. Additionally, some of the stresses scale non-linearly with wall thickness, and increase very rapidly for thick walls of approximately 3 mm or more. Thus it has been confirmed from the model and lamp experiments that the lowest stress is obtained for wall thickness between approximately 1.0 and 3.0 mm, and more preferably 1.5 and 2.5 mm for a 400 W arctube having OD in the range 23 to 33 mm.

In order to scale the preferred range of T to other lamp wattages P, the ratio of Major Outer Diameter to the Wall Thickness OD/T should be approximately constant, in the range of OD/T=8 to 33, more preferably 10 to 20.

It will also be appreciated that all four factors (OD, AR, R, and T) have been identified, and any one of these factors or any combination of these factors, including using all four preferred ranges, results in substantial decrease in the development of cracks that result in ultimate failure and reduced life of the lamp.

The present development of a ceramic arctube in place of the quartz arctube indicates a much slower loss of Na through polycrystalline alumina (PCA) relative to fused silica (quartz) that can enable lamp life of approximately 50,000 hours. Although PCA ceramic can operate this long at temperatures ranging from about 100-200 K higher than quartz, PCA is much more susceptible to cracking due to tensile stresses in the arctube body or arctube envelope as noted above, especially at high temperatures where the material strength can be compromised. The key to minimizing the stress and maximizing the lamp life is to minimize temperature differences throughout the ceramic. This includes reducing temperature differences radially through the wall; axially from the “bottom” to the “top” assuming vertical burn; and also azimuthally around the circumference of the ceramic arctube body. Given the unusual toroidal shape of the arc inside the arctube body and the resultant spatially-dependent heat load on the ceramic, along with the necessary geometry transition from the bulbous arc chamber to the at least one thin cylindrical dose/seal leg, the shape and wall thickness of the ceramic must be carefully tailored to move toward a uniform heat load on the ceramic, providing a more uniform temperature distribution, that minimizes the stress in the ceramic.

Preferred ranges of the four key arctube body parameters are identified above. The four parameters of the oblate spheroidal arctube body geometry include (i) control of an outside major diameter, (ii) control of the wall thickness of the arctube body, (iii) control of a radius of curvature in an interconnecting neck between a spheroidal first portion of the arctube body and a leg second portion, and (iv) control of the aspect ratio (a ratio of the major or equatorial axis relative to the minor or polar axis). Modeling predicts a reduction in maximum stress in the arctube body from approximately 200 MPa for the prior art designs to approximately 60-80 Mpa in the present designs that have been modeled and operated as lamps.

Temperatures are only slightly impacted by the radius of curvature of the interconnecting neck between the first and second portions of the arctube body, but stresses are considerably impacted by R1 and a larger radius (less curvature) is desired up to some amount. Beyond some amount, an increase in R1 will produce a local hot or cold spots where the arc is too close to the wall, or too far from the wall, and higher stresses result.

The disclosure has been described with reference to the preferred embodiments. Obviously, modifications and alterations will occur to others upon reading and understanding the preceding detailed description. It is intended that the disclosure be construed as including all such modifications and alterations.

What is claimed is:

1. An electrodeless induction high intensity discharge lamp comprising:
a light-transmissive envelope enclosing a discharge chamber and having a generally oblate spheroidal portion and at least one elongated generally cylindrical portion extending therefrom, and a ratio of the major diameter (OD) of the generally oblate spheroidal portion to the radius of curvature on the inside surface of the envelope (R1) between the cylindrical portion and the generally oblate spheroidal portion of about 2 to about 11; and
an annular induction coil surrounding at least in part the spheroidal portion for supplying power from an associated ballast.

2. The lamp of claim 1 wherein a wall loading ranges from about 20 W/cm² to about 45 W/cm².

3. The lamp of claim 1 wherein the spheroidal portion has a major diameter (OD) in the range of approximately 20 to 40 mm for a lamp operating in the range of approximately 200 W to 1000 W.

4. The lamp of claim 1 wherein the spheroidal portion has a major diameter (OD) in the range of approximately 23 to 33 mm for a lamp operating at approximately 400 W.

5. The lamp of claim 1 wherein the envelope has a wall thickness (T) on the order of approximately 1.0 to 3.0 mm.

6. The lamp of claim 1 wherein the spheroidal portion has an aspect ratio (AR) on the order of approximately 1.1 to 2.0.

7. The lamp of claim 6 wherein inner and outer walls have substantially the same radii (R₁=R₂) through the neck portion.

8. The lamp of claim 1 wherein the ballast provides power at a frequency of approximately 13.56 megahertz.

9. The lamp of claim 1 wherein the envelope is one of a ceramic and quartz arc chamber that contains a metal halide fill.

10. The lamp of claim 1 further comprising a conductive starter member that extends adjacent the cylindrical portion of the envelope for creating an electric field in the cylindrical portion.

11. The lamp of claim 1 wherein the lamp operates at approximately 200-1000 watts, and preferably at approximately 400 watts.

12. An electrodeless induction metal halide (MH) lamp comprising:
a hermetically sealed light-transmissive ceramic arctube body enclosing a discharge chamber having a generally oblate spheroidal first portion and at least one leg portion extending from a pole region of the spheroidal portion that includes an elongated small diameter portion in the leg portion that communicates with a generally spheroidal chamber in the spheroidal first portion, a ratio (OD/R1) of a major diameter (OD) of the generally oblate spheroidal portion to a radius of curvature (R1) on an inside surface of the arctube body between the leg portion and the generally oblate spheroidal portion of about 2 to about 11;
an annular induction coil portion disposed in surrounding relation with the spheroidal portion of the arctube body.

13. The MH lamp of claim 12 wherein the arctube body has a major diameter (OD) in the range of approximately 26 to 30 mm for a lamp operating at approximately 400 W.

14. The MH lamp of claim 12 wherein the arctube body has a wall thickness (T) on the order of approximately 1.5 to 2.5 mm.

15. The MH lamp of claim 12 wherein the spheroidal portion has an aspect ratio (AR) on the order of approximately 1.3 to 1.6.

16. The MH lamp of claim 12 wherein a wall loading ranges from about 25 W/cm² to about 35 W/cm².

17. The lamp of claim 12 wherein the lamp operates at approximately 200-1000 watts.

18. A method of manufacturing an electrodeless lamp comprising:
providing a light-transmissive envelope having a generally oblate spheroidal portion;
forming at least one elongated generally cylindrical portion extending from the envelope and enclosing a discharge chamber,
transitioning between the spheroidal portion and the generally cylindrical portion to define a ratio (OD/R1) of a major diameter (OD) of the generally oblate spheroidal portion to a radius of curvature on an inside surface of the envelope (R1) between the generally cylindrical portion and the generally oblate spheroidal portion of about 2 to about 11; and
at least partially surrounding the spheroidal portion with an induction coil for supplying power from an associated ballast.

19. The method of claim 18 further including forming the spheroidal portion to have a major diameter ranging from about 20 to 40 mm.

20. The method of claim 18 further including forming the envelope to have a wall thickness on the order of approximately 1.0 to 3.0 mm.

21. The method of claim 18 further including forming the spheroidal portion to have an aspect ratio on the order of approximately 1.1 to 2.0.
